(19) United States
(12) Patent Application Publication
(10) Pub. No.: US 2026/0046181 A1
(43) Pub. Date: Feb. 12, 2026

(54) ELECTRICALLY SMALL NON-LTI ANTENNA MODULATION SCHEMA

(71) Applicant: VIRGINIA TECH INTELLECTUAL PROPERTIES, INC., Blacksburg, VA (US)

(72) Inventor: Majid Manteghi, Blacksburg, Montgomery, VA (US)

(21) Appl. No.: 19/100,414

(22) PCT Filed: Aug. 3, 2023
(86) PCT No.: PCT/US2023/071622

§ 371 Date: Jan. 31, 2025

Related U.S. Application Data
(60) Provisional application No. 63/370,316, filed on Aug. 3, 2022.

(51) Int. Cl. H04L 27/12; H01Q 5/307

(52) U.S. Cl. CPC H04L 27/12; H01Q 5/307

(57) ABSTRACT

Modulation schemas for electrically-small, non-linear-and-time-invariant (non-LTI) antennas are described. A first antenna modulation circuit selectively transmits a first signal at a first predetermined frequency and a second predetermined frequency via a first electrically-small antenna (ESA) according to a first modulation schema. A second antenna modulation circuit selectively transmits a second signal at a third predetermined frequency and a fourth predetermined frequency via a second electrically-small antenna according to a second modulation schema. A receiver circuit configured receives a radiated signal being a total of the first signal and the second signal, and demodulates the radiated signal.

### CROSS-REFERENCE TO RELATED APPLICATION

This application claims the benefit of and priority to U.S. Provisional Patent Application No. 63/370,316 filed Aug. 3, 2022, entitled “MODULATION SCHEMAS FOR NON-LTI ANTENNAS,” the contents of which being incorporated by reference in its entirety herein.

### BACKGROUND

A linear time-invariant (LTI) system is a system that produces an output signal based on an input signal, subject to constraints of linearity and time-invariance. Many conventional antennas have been modeled and designed as components in LTI-based systems. However, some antennas have been designed for use in other types of systems. In the design and use of non-linear-and-time-invariant (non-LTI) antennas, various modulation schemes exist with varying capabilities. Due to the limited number of modulation schemes, bottlenecks are created when attempting to increase communication speeds despite advances in computer hardware and software using existing antennas. For instance, amplitude shift keying (ASK), frequency shift keying (FSK), on-off keying (OOK), amplitude modulation (AM), and like modulation schemes are commonly employed. However, these modulation schemes can be inefficient from a spectrum perspective in many cases.

### BRIEF SUMMARY

Modulation schemas for electrically-small, non-linear-and-time-invariant (non-LTI) antennas are described. In a first aspect, a system is described, including: a first antenna modulation circuit configured to selectively transmit a first signal at a first predetermined frequency and a second predetermined frequency via a first electrically-small antenna (ESA) according to a first modulation schema, the first and second predetermined frequencies being different from one another; a second antenna modulation circuit configured to selectively transmit a second signal at a third predetermined frequency and a fourth predetermined frequency via a second electrically-small antenna according to a second modulation schema, the third and fourth predetermined frequencies being different from one another; and a receiver circuit configured to receive a radiated signal being a total of the first signal and the second signal, and demodulate the radiated signal.

At least one of the first antenna modulation circuit and the second antenna modulation circuit include two inductors of equal inductance that connect to a source and a respective antenna. The first modulation schema and the second modulation schema are different from one another. The first modulation schema and the second modulation schema are selected from a group consisting of amplitude shift keying (ASK); frequency shift keying (FSK); on-off keying (OOK); and amplitude modulation (AM).

The system further includes a third antenna modulation circuit configured to selectively transmit a third signal at a fifth predetermined frequency and a sixth predetermined frequency via a third electrically-small antenna, the fourth and fifth predetermined frequencies being different from one another; and the radiated signal is the total of the first signal, the second signal, and the third signal. The first predetermined frequency is a resonant frequency in the first antenna modulation circuit and is within ±5% MHz of the second predetermined frequency, and the third predetermined frequency is a resonant frequency in the third antenna modulation circuit and is within ±5% MHz of the fourth predetermined frequency.

The first electrically-small antenna is an electric antenna, and the second electrically-small antenna is a magnetic antenna. At least one of the first antenna modulation circuit and the second antenna modulation circuit includes: a source, a low pass filter in series with the source, a plurality of inductors in series with the low pass filter, a plurality of switches, and an antenna, wherein each of the switches is in parallel with a respective one of the inductors; and a switch control switch and switch control circuitry connected to the switch control switch that toggles the switch control switch between on and off, wherein the switch control switch is coupled between a first subset of the inductors and a second subset of the inductors.

The first antenna modulation circuit is not connected to the second antenna modulation circuit. The first antenna modulation circuit and the second antenna modulation circuit are in close proximity to one another.

In a second aspect, a method is described, including: selectively transmitting, using a first antenna modulation circuit, a first signal at a first predetermined frequency and a second predetermined frequency via a first electrically-small antenna (ESA) according to a first modulation schema, the first and second predetermined frequencies being different from one another; selectively transmitting, using a second antenna modulation circuit, a second signal at a third predetermined frequency and a fourth predetermined frequency via a second electrically-small antenna (ESA) according to a second modulation schema, the third and fourth predetermined frequencies being different from one another; and receiving, using a receiver circuit, a radiated signal, the radiated signal being a total of the first signal and the second signal, and demodulating the radiated signal.

At least one of the first antenna modulation circuit and the second antenna modulation circuit include two inductors of equal inductance that connect to a source and a respective antenna. The first modulation schema and the second modulation schema are different from one another. The first modulation schema and the second modulation schema are selected from a group consisting of amplitude shift keying (ASK); frequency shift keying (FSK); on-off keying (OOK); and amplitude modulation (AM).

The method further includes selectively transmitting, using a third antenna modulation circuit, a third signal at a fifth predetermined frequency and a sixth predetermined frequency via a third electrically-small antenna, the fifth and sixth predetermined frequencies being different from one another; and the radiated signal is the total of the first signal, the second signal, and the third signal.

The first predetermined frequency is a resonant frequency in the first antenna modulation circuit and is within ±5% MHz of the second predetermined frequency, and the third predetermined frequency is a resonant frequency in the third antenna modulation circuit and is within ±5% MHz of the fourth predetermined frequency. The first electrically-small antenna is an electric antenna, and the second electrically-small antenna is a magnetic antenna.

At least one of the first antenna modulation circuit and the second antenna modulation circuit includes: a source, a low pass filter in series with the source, a plurality of inductors in series with the low pass filter, a plurality of switches, and an antenna, wherein each of the switches is in parallel with a respective one of the inductors; and a switch control switch and switch control circuitry connected to the switch control switch that toggles the switch control switch between on and off, wherein the switch control switch is coupled between a first subset of the inductors and a second subset of the inductors.

The first antenna modulation circuit is not connected to the second antenna modulation circuit. The first antenna modulation circuit and the second antenna modulation circuit are in close proximity to one another.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding or similar, but not necessarily the same, parts throughout the several views.

FIG. 1A is a simplified representation of various antenna topologies according to various embodiments of the present disclosure.

FIGS. 1B and 1C are circuit diagrams for modulation circuits for a frequency shift keying (FSK) topology using an electric antenna according to various embodiments of the present disclosure.

FIGS. 2A and 2B are circuit diagrams for modulation circuits for a frequency shift keying topology using a magnetic antenna according to various embodiments of the present disclosure.

FIGS. 3A and 3B are circuit diagrams for modulation circuits for an amplitude shift keying (ASK) topology using an electric antenna according to various embodiments of the present disclosure.

FIGS. 4A-4D are circuit diagrams for modulation circuits for amplitude shift keying topology using a magnetic antenna according to various embodiments of the present disclosure.

FIGS. 5A-5C are circuit diagrams for modulation circuits for amplitude modulation (AM) topology using an electric antenna according to various embodiments of the present disclosure.

FIGS. 6A-6C are circuit diagrams for modulation circuits for AM topology using a magnetic antenna according to various embodiments of the present disclosure.

FIG. 7 is a circuit diagram for a modulation circuit for an modulation-level (M-level) continuous-phase frequency shift (MCPFSK) topology using an electric antenna according to various embodiments of the present disclosure.

FIG. 8 is a circuit diagram for a modulation circuit for an M-level continuous-phase frequency shift topology using a magnetic antenna according to various embodiments of the present disclosure.

FIG. 9 are examples of multi-element radiating structures according to various embodiments of the present disclosure.

FIG. 10A is an example of a multi-element radiating structure, namely, an antenna having four radiating loops according to various embodiments of the present disclosure.

FIG. 10B is an example of a multi-element radiating structure, namely, an antenna having various electrical and magnetic antennas according to various embodiments of the present disclosure.

FIG. 11 is a circuit diagram according to various embodiments of the present disclosure.

FIGS. 12A-12D are simulation results of the circuit diagram of FIG. 11 according to various embodiments of the present disclosure.

FIG. 13 is a flowchart illustrating an example modulation schema according to various embodiments of the present disclosure.

### DETAILED DESCRIPTION

The present disclosure relates to modulation schemas for electrically-small, non-linear-and-time-invariant (non-LTI) antennas. As briefly noted above, due to a limited number of modulation schemes, bottlenecks are created when attempting to increase communication speeds despite advances in computer hardware, software, and other communication technology. For instance, amplitude shift keying (ASK), frequency shift keying (FSK), on-off keying (OOK), amplitude modulation (AM), and like modulation schemes are often employed. However, these modulation schemes are inefficient from a spectrum perspective in many cases. More sophisticated modulation schemes are desirable, especially those capable of boosting spectrum efficiency and those capable of incorporating digital modulations.

According to various embodiments as described herein, a modulation-level (M-level) continuous phase frequency shift keying (MCPFSK) schema, Frequency-Division Multiplexing (FDM) schema, and various combinations of these and other available schemas are described for transmission and receipt of communication data. The narrowband nature of electrically-small-antennas (ESAs) is leveraged to provide an antenna system having multiple antenna circuits tuned to predetermined frequencies. The predetermined frequencies may vary slightly (e.g., ±5%) from one another in some cases. Then, each circuit may be independently modulated using, for example, ASK, FSK, OOK, AM, other modulation schemes, and/or any combination thereof. Circuit topologies may vary according to a type of antenna employed. For instance, different topologies for electric antennas (e.g., dipole, monopole, etc.) and magnetic antennas (e.g., loop antennas) may be employed, as will be described.

As such, independent modulation of each antenna element is made possible, encompassing ASK, FSK, OOK, AM, and/or other modulation schemes. Initially, fundamental modulations applied to each individual antenna element are described.

In some implementations, all wideband modulations are implemented employing soft-switching techniques, such as those that alter switching conditions of power switches (e.g., MOSFETs, IGBTs, or diodes) to achieve zero or near-zero voltage or current across them during the switching transitions. This, in turn, can reduce or eliminate switching losses and associated heat, noise, and electromagnetic interference. Furthermore, a realization of various modulations can involve selective switching of the resonant frequency, achieved by alternating between different reactive components using switches, or by switching a signal magnitude. Input data is capable of being applied to the various embodiments either through a voltage source or by adjusting switching intervals.

The present disclosure further discloses a resonant structure whereby a capacitor can be charged or current can be initiated in an inductor. Subsequently, the reactive elements are connected to the radiating elements, which can include an inductor (e.g., loop antenna) or a capacitor (e.g., monopole, dipole, patch antenna, etc.), thus establishing resonance. In various embodiments as will be described, each antenna structure can have a dual counterpart. Electric antennas have their corresponding magnetic antennas, and the modulating circuitry associated with each antenna structure can exhibit duality as well. This duality principle provides a comprehensive framework for understanding and implementing various embodiments of the present disclosure.

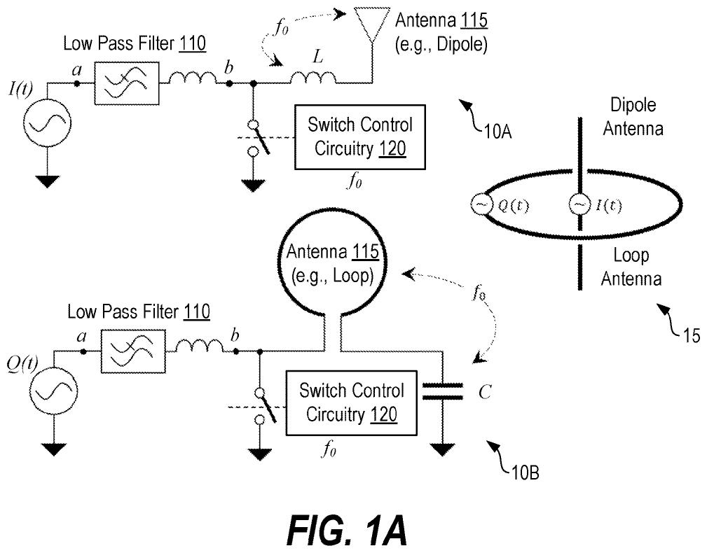

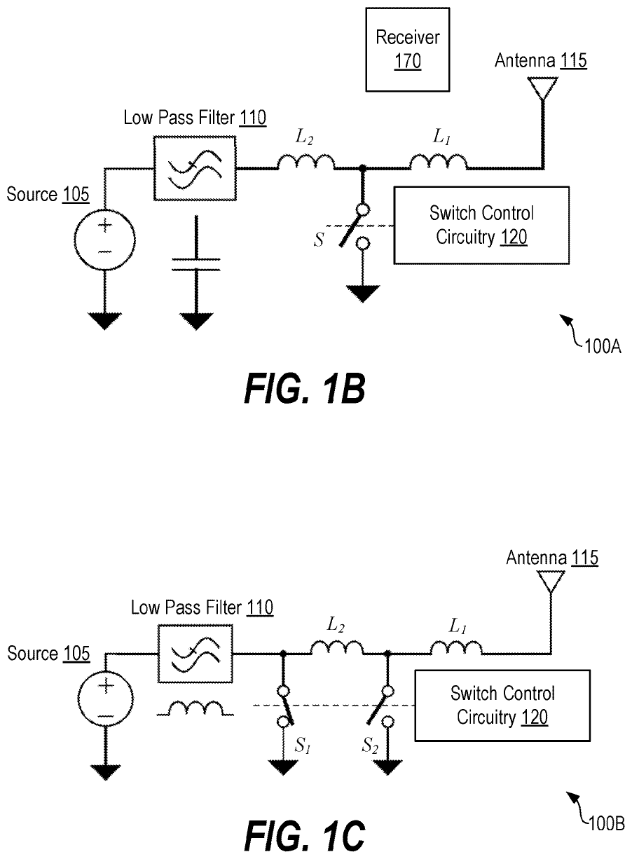

Turning now to the drawings, FIGS. 1A-1C, 2A-2B, 3A-3B, 4A-4B, 5A-5B, 6A-6C, 7, and 8 are various circuit diagrams showing examples of modulation circuits. The modulation circuits are capable of transmitting data in accordance with various modulation schemas according to various embodiments of the present disclosure. As described below, each of the modulation circuits can include a source, a low pass filter, active components, passive components, an antenna, one or more switches, switch control circuitry, as well as other components not shown or described. The circuit diagrams are representative, and certain components may be omitted from the diagrams for simplicity. While a single source is shown in various embodiments, it is understood that the source can include one or more sources. For instance, in some implementations, a first source can provide a modulation signal and a second source can provide an electrical signal, such as a periodic electrical signal, in the modulation circuits.

A receiver or receiver circuitry thereof can receive a radiated signal from one or more of the modulation circuits shown or described herein. The receiver circuit can also demodulate the signal to access the data as derived from the signal. The radiated signal utilizes a wireless communication spectrum more efficiently as compared to known techniques, as will become apparent.

Depending on the particular implementation or modulation schema relied upon among the modulation circuits, the antennas described herein can be embodied as electrically-small or electrically-short antennas. Typical dipole or monopole antennas are designed to have an electrical length of ¼ or ½ of the wavelength of the carrier frequency for the modulation scheme used. In that sense, the electrically-small or electrically-short antennas described herein can be smaller in electrical length than a typical dipole or monopole antenna that would have been used for the resonant frequencies used for transmission (e.g., f₁, f₁, etc.), as described below. Alternatively, the antennas described herein can include an electrically-small antenna or, more specifically, an antenna having a ka factor that is less than one, where k is wave number and a is the radius of the smallest enclosing sphere. The antennas described herein can include electric antennas and magnetic antennas, as will be described.

Various embodiments of the present disclosure utilize two resonant structures to facilitate radiation of an arbitrary waveform. A structure of a quadrature-phase signal and an in-phase signal can be dual to each other. According to various embodiments, resonant structures will be described and subsequently expanded to encompass other resonant structures, thereby leveraging the principle of duality. As such, operation of the various embodiments described herein and applicability to both quadrature and in-phase signals will become apparent.

FIG. 1A shows a simplified representation of an in-phase upconverting antenna configuration according to various embodiments. An analog source, represented as a signal I(t), corresponds to an in-phase component of a baseband signal. Signal I(t) is connected to port “a” of a low-pass filter, which incorporates an inductor as its final element connected to port “b.” To ensure adequate radiated power, a buffer amplifier can be included in analog source I(t). A switch is connected to port “b” of the low-pass filter 110, along with an additional inductor denoted as “L.” Inductor L is connected to an electric antenna, such as a monopole, dipole, or microstrip patch antenna, with the particular embodiment showing a dipole configuration.

The switch periodically connects port b of the low-pass filter 110 to ground and subsequently disconnects it for a brief period. This switching occurs at a frequency of f₀ or its harmonics, with the duration of each disconnect being significantly shorter than the period 1/f₀. The low-pass filter 110 facilitates periodic adjustment of current of the inductor L, which is proportional to the input signal I(t). This particular antenna structure functions as an upconverter, with the signal I(t) serving as the envelope of a sinusoidal waveform at the frequency f₀. As such, FIG. TA shows a modulating circuit 10A for an in-phase upconverting antenna, and a modulation circuit 10B for a quadrature phase upconverting antenna. Schematic 20 of FIG. TA shows a dipole loop combination that enables circular polarization single sideband radiation.

At the far zone, electric field intensities radiated by an ideal dipole and a small loop antenna are expressed as:

$${E}_{dipole} = jk η \frac{{I}_{dipole} L}{2} \frac{{e}^{- j k r}}{4 π r} sin θ \hat{θ} , \qquad ( eq . 1 )$$

$${E}_{loop} = {k}^{2} η {I}_{loop} S \frac{{e}^{- j k r}}{4 π r} sin θ \hat{ϕ} . \qquad ( eq . 2 )$$

To achieve circular polarization, the current ratio between the dipole and loop antennas can satisfy the following relationship:

$$\frac{{I}_{dipole}}{{I}_{loop}} = \frac{2 kS}{L} . \qquad ( eq . 3 )$$

Notably, η represents the impedance of free space, j is the imaginary unit, k is the wave number, L is the length of the dipole antenna, S is the area of the loop antenna, r represents the distance from the source, θ represents the elevation angle, and ϕ represents the azimuthal angle.

FIGS. 1B and 1C are circuit diagrams of example modulation circuits for a frequency shift keying topology. FIG. 1B illustrates a modulation circuit 100A, and FIG. 1B illustrates a modulation circuit 100B. In FIG. 1B, the modulation circuit 100A includes a source 105, a low pass filter 110, inductors L₁, L₂, an antenna 115, a switch S, switch control circuitry 120, as well as other components not shown or described. The antenna 115 can include an electric antenna, such as a monopole antenna, a dipole antenna, or like electric antenna. The antenna 115 can be embodied as an electrically-small antenna (ESA), such as an antenna having a ka factor that is less than one.

In FIG. 1C, the modulation circuit 100B includes a source 105, a low pass filter 110, inductors L₁, L₂, an antenna 115, switches S₁, S₂, switch control circuitry 120, as well as other components not shown or described. Like FIG. 1B, the antenna 115 includes an electric antenna, such as a monopole antenna, a dipole antenna, or like electric antenna and can be embodied as an ESA, such as an antenna having a ka factor that is less than one.

The low pass filter 110 shown in FIG. 1B can be implemented as filter that passes signals having a frequency lower than a predetermined cutoff frequency and attenuates signals having frequencies higher than the cutoff frequency. The low pass filter 110 can be embodied as a network of passive devices, such as a resistive-capacitive (RC) network of any suitable arrangement. In some implementations, a final component of the low pass filter 110 in the modulation circuit 100A can include a capacitor. The source 105 can be embodied as a direct current (DC) power source, such as a battery, or other type of power source. When coupled in the modulation circuits 100A and 100B, the source 105 can energize and generate FSK signals for transmission by the antenna 115, as described herein. The inductors L₁, L₂ can be embodied as any suitable type and style of inductors. The inductances of the inductors L₁, L₂ can be selected or tailored, respectively, to achieve a particular frequency of resonance in the modulation circuits as described herein.

The switch control circuitry 120 can include processing circuitry and memory and can be embodied as one or more microprocessors, application specific integrated circuits (ASICs), programmable logic devices (e.g., field-programmable gate array (FPGAs), and complex programmable logic devices (CPLDs)), as examples. The switch control circuitry 120 can operate at the direction of software or program instructions in some cases, as described below, which may be executed by the processing circuitry of the switch control circuitry 120. In other cases, the switch control circuitry 120 can be embodied as discrete logic or discrete logic circuitry configured to generate the modulating or switch control signals described herein.

Driven by modulating or control signals from the switch control circuitry 120, the switches S, S₁, and S₂ are respectively directed to turn off (i.e., open circuit) and turn on (i.e., closed circuit) to control the signal transmitted by the antenna 115. In the modulation circuit 100A, the switch control circuitry 120 is configured to direct the operation of the switch S and, as a result, control the signal transmitted by the antenna 115 for FSK modulation. In operation, the inductor L₁ and the antenna 115 resonate at a first predetermined frequency f₁ based on energy provided from the source 105. The effective electrical capacitance of the antenna 115 and the inductance of the inductor L₁ can be tailored or selected to determine the first predetermined frequency f₁. Additionally, the inductors L₁, L₂ and the antenna 115 can also resonate at a second predetermined frequency f₂ that is less than the frequency f₁ based on energy provided from the source 105. The capacitance of the antenna 115 and the combined inductance of the inductors L₁, L₂ can be tailored or selected to determine the second predetermined frequency f₂. The frequencies f₁ and f₂ can range among the embodiments and be tailored by design, based on the electrical characteristics (e.g., the inductance, capacitance, resistance, etc.) of the resonating components in the modulation circuits described herein.

With reference to FIG. 1B, through operation of the switch S, the modulation circuit 100A and the antenna 115 can operate and transmit at either the first predetermined frequency f₁ or at the second predetermined frequency f₂. More particularly, when the switch control circuit 120 provides a control signal to close the switch S, then the inductor L₁ and the antenna 115 resonate at the first predetermined frequency f₁. Further, when the switch control circuit 120 provides a control signal to open the switch S, then the inductors L₁, L₂ and the antenna 115 (in connection with the low pass filter 110) resonate at the second predetermined frequency f₂.

The switch control circuit 120 can be configured to direct the switch S to be actuated (i.e., toggled from open or ON to closed or OFF, or from closed to open) at a time or a condition when a voltage or electric potential across the switch S is at a zero potential difference across it, nearly at zero, or below a predetermined threshold. Thus, when the voltage across the switch S is zero, which can correspond to a time when the inductor currents in the inductors L₁, L₂ are at a maximum, the switch control circuit 120 is configured to switch or toggle the switch S between ON and OFF states (or between OFF and ON states), thereby modulating the signal communicated via the antenna 115 between the predetermined frequencies f₁ and f₂.

The source 105 can be embodied as a DC power source, such as a battery, or other type of power source. When coupled in the modulation circuit 100A, the source 105 can energize and generate an FSK signal in the modulation circuit 100A with a constant amplitude, as one example. In other cases, the modulation circuit 100A can also modulate the amplitude of the FSK signal.

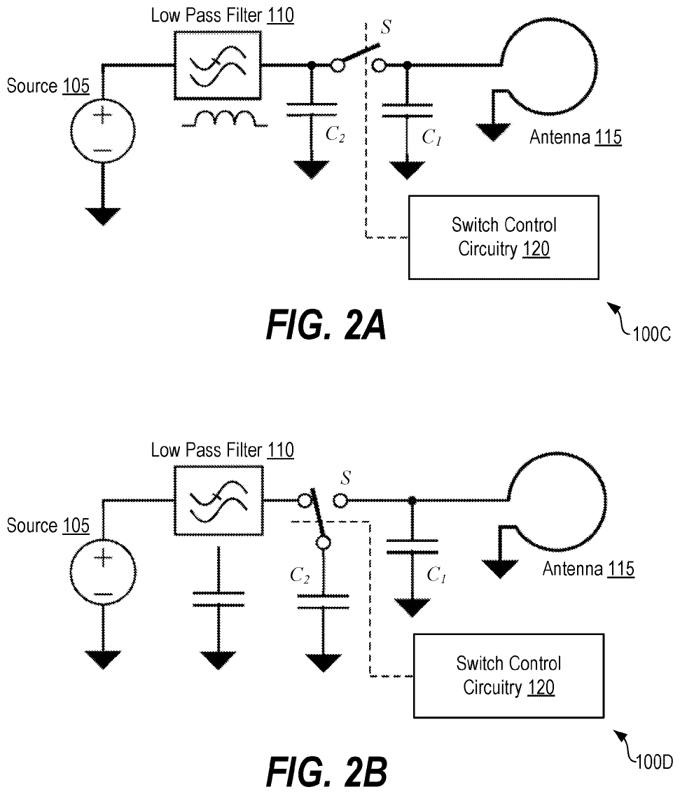

The modulation circuit 100A includes a single switch S and a low pass filter 110. In some implementations, a final component of the low pass filter 110 can include a capacitor. Notably, a similar topology can be employed in the circuit depicted in FIGS. 2A and 2B, where the final component of the low pass filter 110 can include an inductor in place of the capacitor. When the voltage across a respective switch equals zero and the inductor currents are at a maximum, the respective switch toggles between ON and OFF, thereby modulating a signal communicated via the antenna 115. A receiver 170 is shown capable of receiving a radiated signal transmitting by at least one of the modulation circuits 100A, 100B. For explanatory purposes, each of the modulation circuits 100 described herein can be used in conjunction with a receiver 170 and the reference component will not be repeated in each figure.

With reference to FIG. 1C, through operation of the switches S₁ and S₂, the modulation circuit 100B and the antenna 115 can operate and selectively transmit at either a first predetermined frequency f₁ or at a second predetermined frequency f₂. More particularly, when the switch control circuit 120 provides a control signal to close the switch S₁, then the inductor L₁ and the antenna 115 resonate at the first predetermined frequency f₁. Further, when the switch control circuit 120 provides a control signal to open the switch S₁ and close the switch S₂, then the inductors L₁, L₂ and the antenna 115 resonate at the second predetermined frequency f₂. The switch control circuit 120 can be configured to direct the switches S₁ and S₂ to be actuated at a time or a condition when a voltage or electric potential across the switches S₁ and S₂, are at a zero potential difference.

Different topologies for magnetic antennas 115 are shown in FIGS. 2A and 2B. FIG. 2A illustrates a modulation circuit 100C, and FIG. 2B illustrates a modulation circuit 100C. In FIG. 2A, the modulation circuit 100C includes a source 105, a low pass filter 110, capacitors C₁, C₂, an antenna 115, a switch S, switch control circuitry 120, as well as other components not shown or described. In FIG. 2B, the modulation circuit 100D includes a source 105, a low pass filter 110, capacitors C₁, C₂, an antenna 115, a switch S, switch control circuitry 120, as well as other components not shown or described. In FIG. 2A, the switch S is positioned between the two capacitors C₁, C₂ that are parallel with one another. In FIG. 2B, the switch S is in series with capacitor C₂.

The magnetic antennas 115 in the modulation circuits 100C and 100D can include, for example, loop antennas, grounded half-loop antennas, and the like. Capacitor C₁ and the antenna 115 resonate at frequency f₁ in both topologies, while capacitors C₁, C₂ and the antenna 115 resonate at frequency f₂ which is less than frequency f₁. The source 105 can include a battery or other power source that generates an FSK signal with a constant amplitude, or the source can carry a waveform and modulate the amplitude of the FSK signal. When current passing through the switches S equals zero and the capacitor voltages are at a maximum, the switches S toggle between ON and OFF based on the control provided from the switch control circuitry 120.

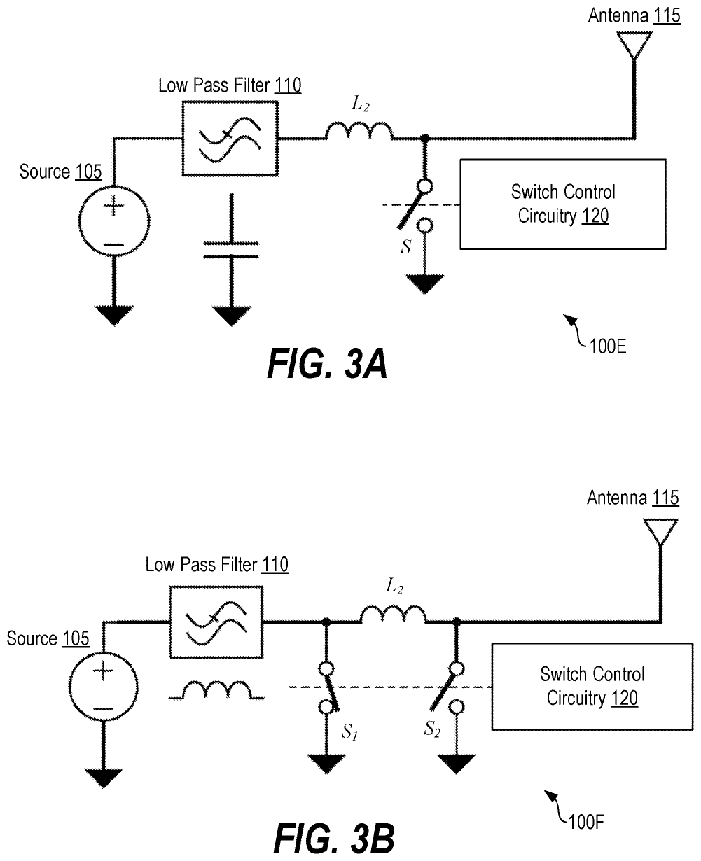

FIG. 3A illustrates a modulation circuit 100E, and FIG. 3B illustrates a modulation circuit 100F. As illustrated in FIGS. 3A and 3D, the first inductor L₁ can be omitted to obtain ASK modulation for the electric antennas 115. The modulation circuit 100E of FIG. 3A includes the source 105, the low pass filter 110, the switch S, the second inductor L₂, the antenna 115, and switch control circuitry 120 in communication with the switch S that toggles the switch S. The modulation circuit 100F of FIG. 3B includes the source 105, the low pass filter 110, switches S₁, S₂, the second inductor L₂, the antenna 115, and switch control circuitry 120 in communication with the switches S₁, S₂, that toggles the switches S₁, S₂. The modulation circuits 100E and 100F in FIGS. 3A and 3B produce an ASK-modulated signals at the antenna port. The ON state frequency is dictated by the resonance frequency of the inductor L₂ and the antenna 115. There is no voltage across the switches S when they are toggled by the switch control circuitry 120.

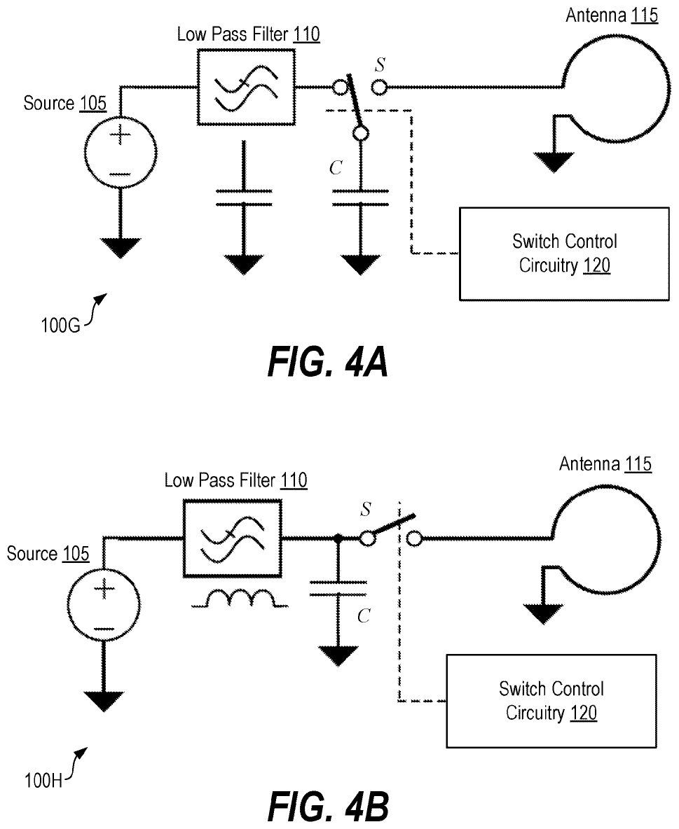

FIG. 4A illustrates a modulation circuit 100G, and FIG. 4B illustrates a modulation circuit 100H. The modulation circuits 100G and 100H in FIGS. 4A and 4B include the source 105, the low pass filter 110, switch S, the capacitor C, the antenna 115, and switch control circuitry 120 in communication with the switch S that toggles the switch S. Both modulation circuits 100G and 100H in FIGS. 4A and 4B generate an ASK-modulated signal at the antenna port. The ON state frequency is dictated by the resonance frequency of C₂ and the antenna 115. There is no current through the switch S when it is toggled by the switch control circuitry 120.

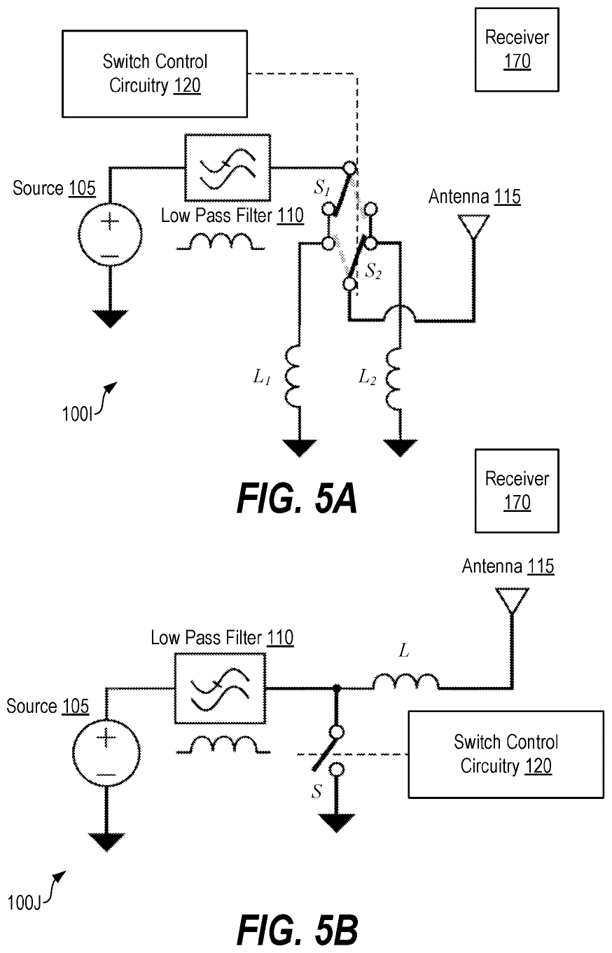

In AM modulation, the magnitude of the signal at each cycle can be controlled. The following topologies show example circuitry for electric ESAs. FIG. 5A depicts a modulation circuit 100I with two equal inductors L₁, L₂ that alternately connect to the source 105 and the antenna 115. L₁ can be defined as equal to L₂ for an AM signal, where the source 105 controls currents flowing through the inductors L₁, L₂. The switch S occurs when the current reaches zero. The modulation circuit of FIG. 5A can further include the source 105, the low pass filter 110, the antenna 115, the switch control circuitry 120, as well as other components not shown or described.

FIG. 5B depicts another modulation circuit 100J for generating AM modulation. The switch S is generally ON; however, for a brief period of time, the switch S can be toggled to OFF, allowing the source-modulated current to modify current in the inductor L. The switching occurs at each zero crossing of the voltage across the switch S. The last component of the low pass filters 110 for both modulation circuits 100I and 100J can include an inductor.

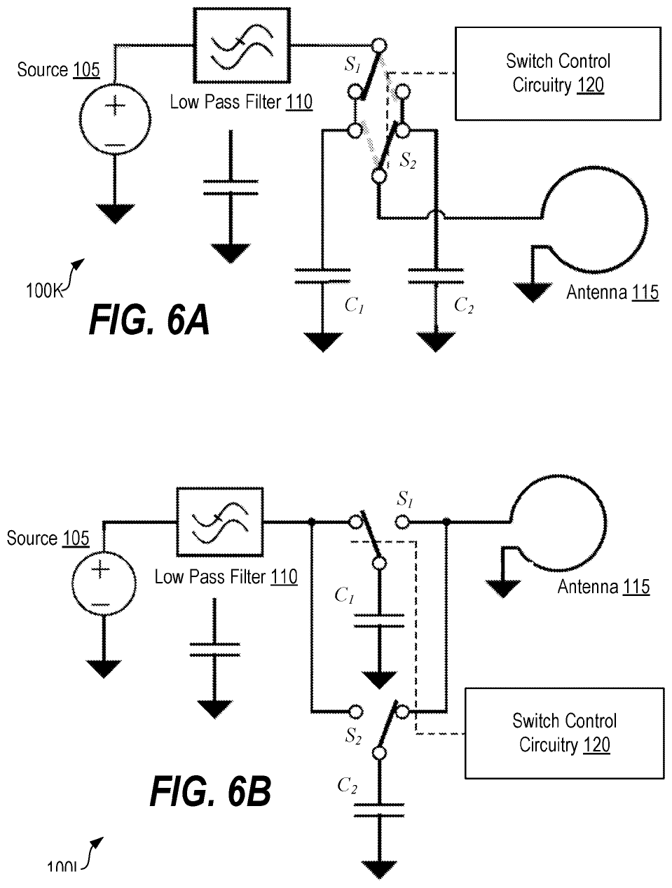

FIG. 6A shows a modulation circuit 100K that includes the source 105, the low pass filter 110, switches S₁, S₂, capacitors C₁, C₁, the antenna 115, and the switch control circuitry 120. The modulation circuit 100K depicted in FIG. 6A modulates the resonant antenna with C₁ or C₂ based on the input provided by the source 105. The values of the capacitors C₁, C₂ can be defined as equal to one another to ensure that each cycle has an equal period. The antenna 115 resonates alternately with each capacitor C every other cycle. At zero crossing of the current, the pair of switches S₁, S₂ will toggle, namely, when the voltage across the capacitor C is at its highest.

FIG. 6B shows a modulation circuit 100L that includes the source 105, the low pass filter 110, switches S₁, S₂, capacitors C₁, C₁, the antenna 115, and the switch control circuitry 120. The modulation circuit 100L depicted in FIG. 6B modulates the resonant antenna with a capacitor C₁ based on the input provided by the source 105. The antenna 115 resonates alternately with each capacitor C every other cycle. At zero crossing of the current, the pair of switches S₁, S₂ will toggle, specifically, when the voltage across the capacitor C is at its highest.

FIG. 6C displays an alternative embodiment of a modulation circuit 100M for generating AM modulation for magnetic antennas 115. Again, the magnetic antenna 115 and the capacitor C are in resonance. In response to the input signal, the switch S closes briefly (relative to the period of resonance) and adjusts the magnitude of the resonance at each cycle. At the current zero crossing, the switch S toggles when the voltage across capacitor C is at its maximum. A last component of the low pass filter 115 can include a capacitor.

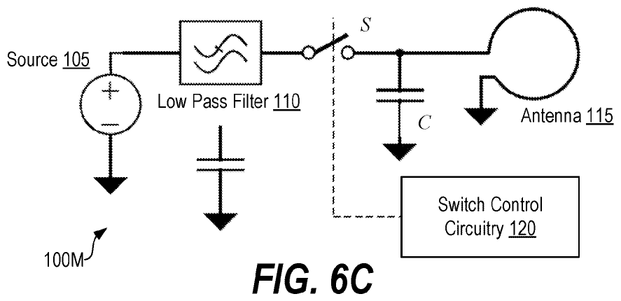

FIG. 7 illustrates a modulation circuit 100N having a multitude of inductors L in parallel with shorting switches S (e.g., as shown in subset 118) and multiple inductors L to the right of a ground switch S_{gnd} (e.g., as shown in subset 121) that enables transmission of a signal that can be altered at each cycle to form an MCPSFK signal. Specifically, FIG. 7 depicts a modulation circuit 100N that can be utilized to achieve M-level continuous-phase frequency shift keying for electric antennas 115. The combination of inductors L in both subsets 118, 121 on alternating sides of the ground switch S_{gnd} is set during the cycle in which the ground switch S_{gnd} is open and at the instant that the current is zero. Furthermore, the last component of the low pass filter 110 can include a capacitor.

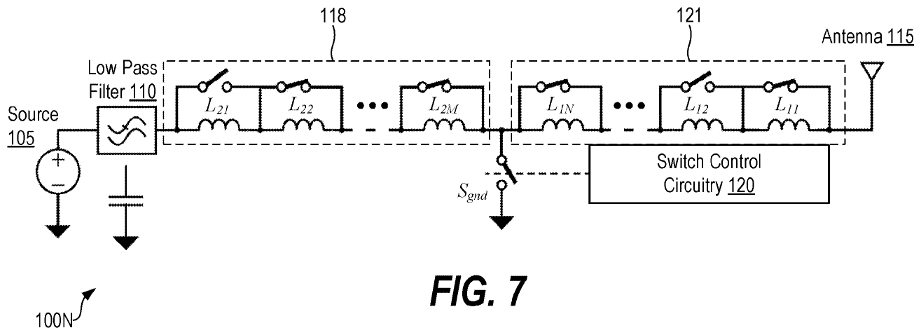

FIG. 8 illustrates a modulation circuit 100O in which multiple capacitors connected to switches S₁ . . . S_{N} enable transmission of a signal that can be altered at each cycle to form an MCPSFK signal. More specifically, FIG. 8 depicts a modulation circuit 100O that can be utilized to achieve M-level continuous-phase frequency shift keying for magnetic antennas 115. When the voltage is at its peak, a combination of capacitors C₁ . . . C_{N} is switched to the antenna 115 to establish the frequency f for each cycle. The final element of a low pass filter 110 can include a capacitor, for example.

Narrow bandwidth of tuned ESAs can be leveraged and a number of ESAs can be positioned in close proximity (e.g., less than one meter) to one another without worrying about coupling. Nevertheless, the proximity of the antennas can depend on the proximity of their resonance frequency. In essence, tightness of physical space can be exchanged for compactness of frequencies. Further, in some implementations, both electric antennas 115 and magnetic antennas 115 can be employed in a single system. As such, the radiating structure can include a multitude of ESAs that can be independently and separated modulated.

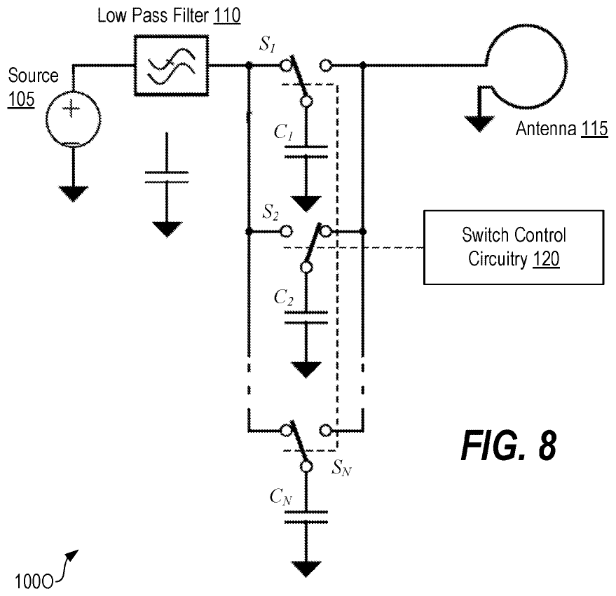

FIGS. 9A-9C illustrate examples of multi-element radiating structures (e.g., antennas 115) controlled by modulation circuits 100a . . . 100n. For instance, FIG. 9A shows a combination of magnetic antennas 115, FIG. 9B shows a combination of electric antennas 115, and FIG. 9C shows a combination of electric antennas 115 and magnetic antennas 115. The narrow bandwidth of each antenna 115 reduces the impact of signals on the other antennas 115. Consequently, each antenna 115 can operate independently, and a radiated signal can be the total of a signal radiated by each antenna 115 of the modulation circuits 100a . . . 100n. For instance, in experiments performed, four loop antennas 115 as a radiating structure were utilized and it was demonstrated that signals at each port are unaffected by signals from other antennas 115.

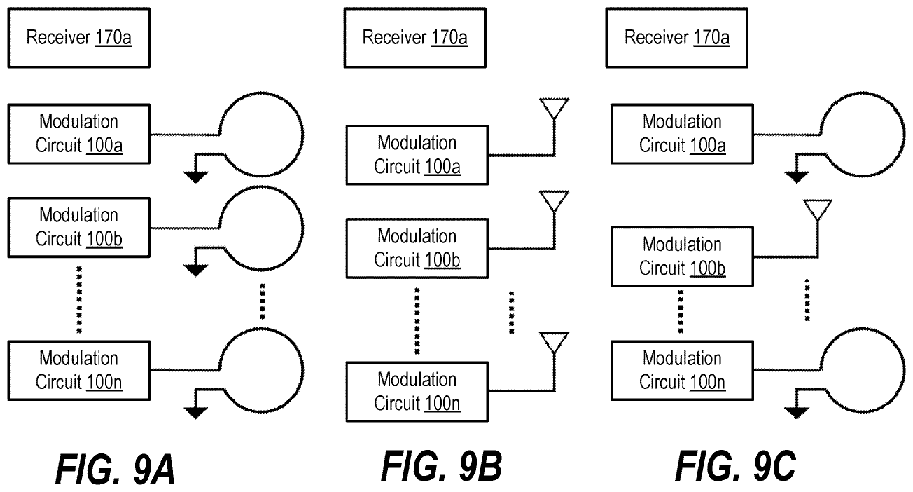

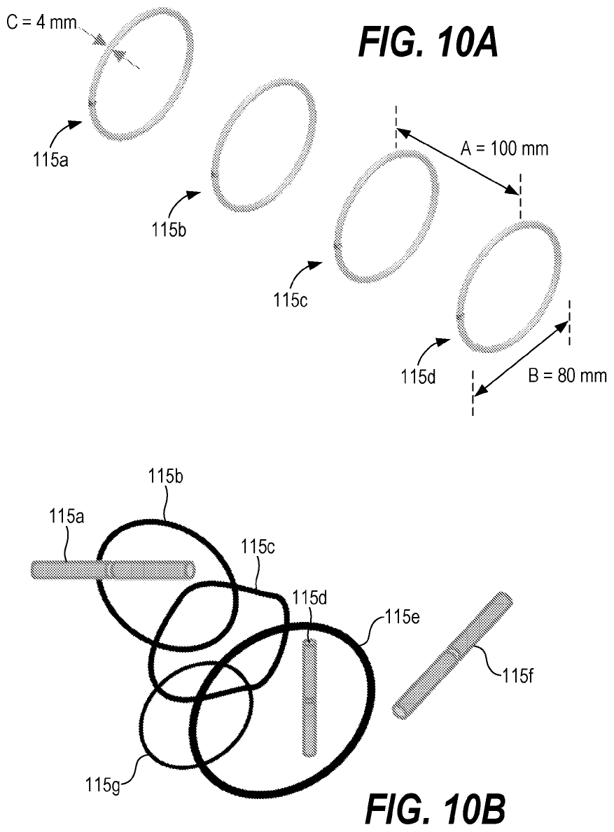

FIG. 10A shows a radiating system formed of a four-loop antenna. It is understood that other number of loops can be employed, such as two, three, five, and so forth. Each loop diameter is 80 mm, and the distance between loops 100 mm, although it is understood that other dimensions can be employed. While FIG. 10A includes only magnetic antennas 115, FIG. 10B illustrates a radiating system formed of a combination of electric antennas 115 and magnetic antennas 115.

Referring to FIG. 10A, an example is a radiating structure includes four loop antennas 115. 70 MHz was a maximum frequency considered in a software simulation. The wavelength is approximately 428 mm, which is at least 5.35 times greater than the diameter of each loop. It is understood that lower frequencies are conceivable and within the scope of the present disclosure. The structure can be simulated using a three-dimensional electromagnetic (EM) simulation software (e.g., HFSS), and the time-domain waveforms can be computed using electronic design automation software (e.g., ADS).

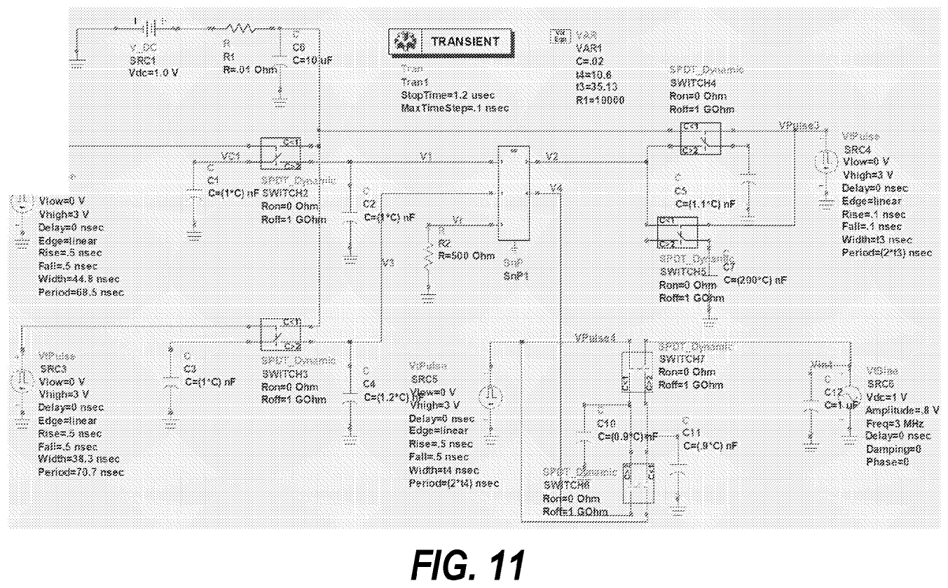

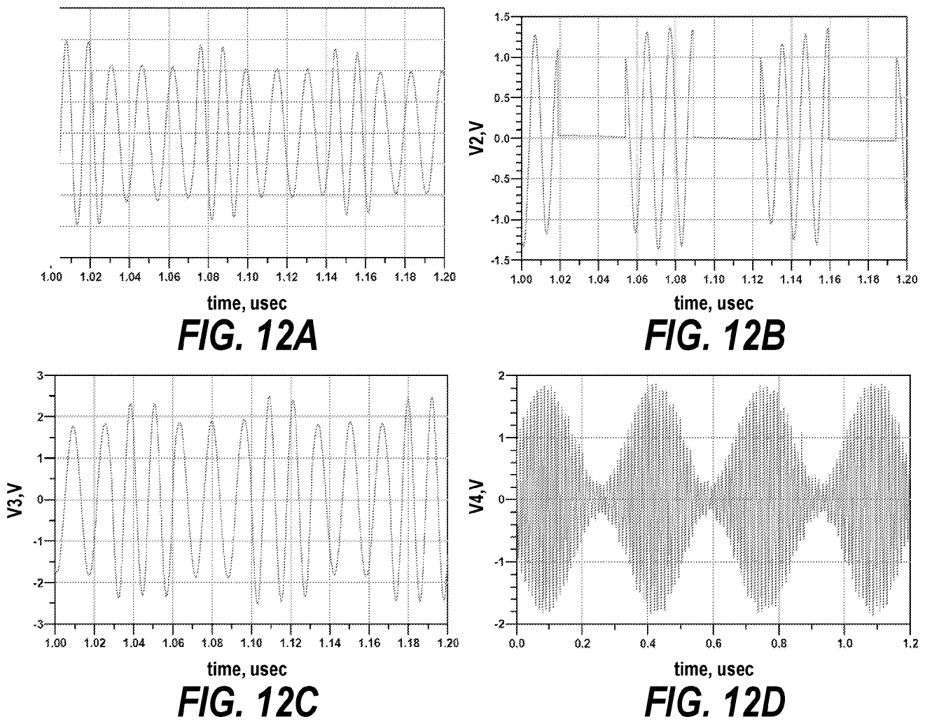

FIG. 11 depicts the simulation model generated by the electronic design automation software. A scattering matrix computed by the three-dimensional EM simulation software was used to simulate different modulation schema simultaneously. As shown in FIGS. 12A-12D all antennas 115 are excited. Antennas one and three were FSK modulated, while antennas two and four were ASK and AM modulated, respectively. These figures suggest that the signals of each antenna 115 are unaffected by those of the other antennas 115.

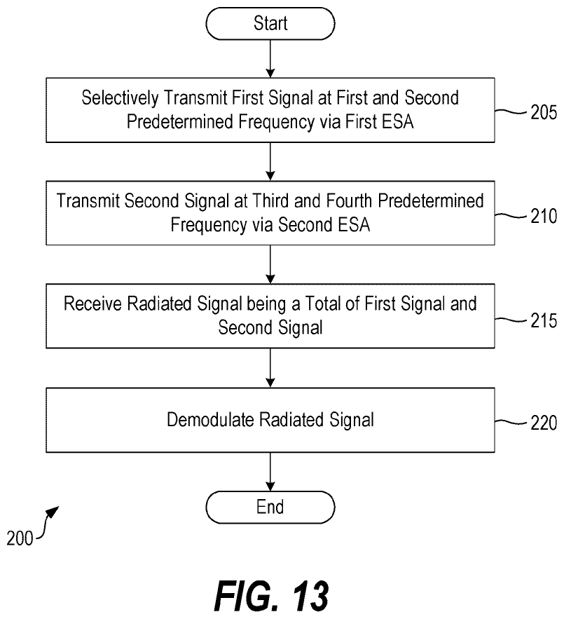

Moving along, FIG. 13 shows a flowchart 200 illustrating an example method in accordance with various embodiments described herein. The method may include, at box 205, selectively transmitting, using a first antenna modulation circuit 100, a first signal at a first predetermined frequency f₁ and a second predetermined frequency f₂ via a first electrically-small antenna 115 according to a first modulation schema. Next, at box 210, the method may include selectively transmitting, using a second antenna modulation circuit 100, a second signal at a third predetermined frequency f₃ and a fourth predetermined frequency f₄ via a second electrically-small antenna according to a second modulation schema, the second predetermined frequency being different than the first predetermined frequency. It is understood that, in some implementations, the first predetermined frequency f₁ and the second predetermined frequency f₂ can be different than the third predetermined frequency f₃ and the fourth predetermined frequency f₂.

At box 215, the method can include receiving, using a receiver 170 (e.g., a receiver circuit), a radiated signal. The radiated signal can be a total of the first signal and the second signal. Finally, at 220, the method can include demodulating the radiated signal, for instance, to access or interpret communication data, as can be appreciated.

In some implementations, and as shown above, at least one of the first antenna modulation circuit 100 and the second antenna modulation circuit 100 can include two inductors L of equal inductance that connect to a source and a respective antenna 115. The first modulation schema and the second modulation schema can be different from one another. The first modulation schema and the second modulation schema can be selected from a group consisting of: amplitude shift keying, frequency shift keying (FSK), on-off keying (OOK), and amplitude modulation (AM), among others.

In some embodiments, the method further can further include selectively transmitting, using a third antenna modulation circuit 100, a third signal at a fourth and fifth predetermined frequency via a third electrically-small antenna 115, the third predetermined frequency being different than the first predetermined frequency and the second predetermined frequency. The radiated signal can thus be the total of the first signal, the second signal, and the third signal.

In some embodiments, the method further can further include transmitting, using a fourth antenna modulation circuit 100, a fourth signal at a sixth and seventh predetermined frequency via a fourth electrically-small antenna 115, the fourth predetermined frequency being different than the first predetermined frequency, the second predetermined frequency, and the third predetermined frequency. The radiated signal can thus be the total of the first signal, the second signal, the third signal, and the fourth signal.

The first predetermined frequency can be a resonant frequency within ±5% MHz of the second predetermined frequency, and the second predetermined frequency can be a resonant frequency within ±5% MHz of the third predetermined frequency. The first electrically-small antenna can be an electric antenna 115, and the second electrically-small antenna can be a magnetic antenna 115.

At least one of the first antenna modulation circuit and the second antenna modulation circuit can include a source 105, a low pass filter 110 in series with the source 105, inductors L in series with the low pass filter 110, a plurality of switches S, and an antenna 115, wherein each of the switches S can be in parallel with a respective one of the inductors L. A switch control switch S and switch control circuitry 120 can be connected to the switch control switch S that toggles the switch control switch between on and off, where the switch control switch S can be coupled between a first subset of the inductors and a second subset of the inductors, as shown in FIG. 7.

In some implementations, the first antenna modulation circuit 100 is not connected to the second antenna modulation circuit 100. However, the first antenna modulation circuit 100 and the second antenna modulation circuit 100 can be in close proximity (e.g., less than 1 m) to one another.

The features, structures, or characteristics described above may be combined in one or more embodiments in any suitable manner, and the features discussed in the various embodiments may be interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

The flowchart shown in FIG. 13 shows an example of the functionality and operation of implementations of components described herein. The switch control circuitry 120 and other components described herein can be embodied in hardware, software, or a combination of hardware and software. If embodied in software, each element can represent a module of code or a portion of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system. If embodied in hardware, each element can represent a circuit or a number of interconnected circuits that implement the specified logical function(s).

The switch control circuitry 120 can include at least one processing circuit. Such a processing circuit can include, for example, one or more processors and one or more storage devices that are coupled to a local interface. The local interface can include, for example, a data bus with an accompanying address/control bus or any other suitable bus structure. The memory device or devices in the switch control circuitry can store data or components that are executable by the processors of the processing circuit of the switch control circuitry 120.

Also, one or more of the components described herein that include software or program instructions can be embodied in any non-transitory computer-readable medium for use by or in connection with an instruction execution system such as, a processor in a computer system or other system. The computer-readable medium can contain, store, and/or maintain the software or program instructions for use by or in connection with the instruction execution system.

A computer-readable medium can include a physical media, such as, magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in one computing device or by using multiple computing devices.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A system, comprising:
a first antenna modulation circuit configured to selectively transmit a first signal at a first predetermined frequency and a second predetermined frequency via a first electrically-small antenna (ESA) according to a first modulation schema, the first and second predetermined frequencies being different from one another;
a second antenna modulation circuit configured to selectively transmit a second signal at a third predetermined frequency and a fourth predetermined frequency via a second electrically-small antenna according to a second modulation schema, the third and fourth predetermined frequencies being different from one another; and
a receiver circuit configured to receive a radiated signal being a total of the first signal and the second signal, and demodulate the radiated signal.

2. The system according to claim 1, wherein at least one of the first antenna modulation circuit and the second antenna modulation circuit comprise two inductors of equal inductance that connect to a source and a respective antenna.

3. The system according to claim 2, wherein the first modulation schema and the second modulation schema are different from one another.

4. The system according to claim 2, wherein the first modulation schema and the second modulation schema are selected from a group consisting of: amplitude shift keying (ASK); frequency shift keying (FSK); on-off keying (OOK); and amplitude modulation (AM).

5. The system according to claim 1, wherein:
the system further comprises a third antenna modulation circuit configured to selectively transmit a third signal at a fifth predetermined frequency and a sixth predetermined frequency via a third electrically-small antenna, the fourth and fifth predetermined frequencies being different from one another; and
the radiated signal is the total of the first signal, the second signal, and the third signal.

6. The system according to claim 5, wherein the first predetermined frequency is a resonant frequency in the first antenna modulation circuit and is within ±5% MHz of the second predetermined frequency, and the third predetermined frequency is a resonant frequency in the third antenna modulation circuit and is within ±5% MHz of the fourth predetermined frequency.

7. The system according to claim 1, wherein the first electrically-small antenna is an electric antenna, and the second electrically-small antenna is a magnetic antenna.

8. The system according to claim 1, wherein at least one of the first antenna modulation circuit and the second antenna modulation circuit comprises:
a source, a low pass filter in series with the source, a plurality of inductors in series with the low pass filter, a plurality of switches, and an antenna, wherein each of the switches is in parallel with a respective one of the inductors; and
a switch control switch and switch control circuitry connected to the switch control switch that toggles the switch control switch between on and off, wherein the switch control switch is coupled between a first subset of the inductors and a second subset of the inductors.

9. The system according to claim 1, wherein the first antenna modulation circuit is not connected to the second antenna modulation circuit.

10. The system according to claim 1, wherein the first antenna modulation circuit and the second antenna modulation circuit are in close proximity to one another.

11. A method, comprising:
selectively transmitting, using a first antenna modulation circuit, a first signal at a first predetermined frequency and a second predetermined frequency via a first electrically-small antenna (ESA) according to a first modulation schema, the first and second predetermined frequencies being different from one another;
selectively transmitting, using a second antenna modulation circuit, a second signal at a third predetermined frequency and a fourth predetermined frequency via a second electrically-small antenna (ESA) according to a second modulation schema, the third and fourth predetermined frequencies being different from one another; and
receiving, using a receiver circuit, a radiated signal, the radiated signal being a total of the first signal and the second signal, and demodulating the radiated signal.

12. The method according to claim 11, wherein at least one of the first antenna modulation circuit and the second antenna modulation circuit comprise two inductors of equal inductance that connect to a source and a respective antenna.

13. The method according to claim 12, wherein the first modulation schema and the second modulation schema are different from one another.

14. The method according to claim 12, wherein the first modulation schema and the second modulation schema are selected from a group consisting of: amplitude shift keying (ASK); frequency shift keying (FSK); on-off keying (OOK);
and amplitude modulation (AM).

15. The method according to claim 11, wherein:
the method further comprises selectively transmitting, using a third antenna modulation circuit, a third signal at a fifth predetermined frequency and a sixth predetermined frequency via a third electrically-small antenna, the fifth and sixth predetermined frequencies being different from one another; and
the radiated signal is the total of the first signal, the second signal, and the third signal.

16. The method according to claim 15, wherein the first predetermined frequency is a resonant frequency in the first antenna modulation circuit and is within ±5% MHz of the second predetermined frequency, and the third predetermined frequency is a resonant frequency in the third antenna modulation circuit and is within ±5% MHz of the fourth predetermined frequency.

17. The method according to claim 11, wherein the first electrically-small antenna is an electric antenna, and the second electrically-small antenna is a magnetic antenna.

18. The method according to claim 11, wherein at least one of the first antenna modulation circuit and the second antenna modulation circuit comprises:
a source, a low pass filter in series with the source, a plurality of inductors in series with the low pass filter, a plurality of switches, and an antenna, wherein each of the switches is in parallel with a respective one of the inductors; and
a switch control switch and switch control circuitry connected to the switch control switch that toggles the switch control switch between on and off, wherein the switch control switch is coupled between a first subset of the inductors and a second subset of the inductors.

19. The method according to claim 11, wherein the first antenna modulation circuit is not connected to the second antenna modulation circuit.

20. The method according to claim 11, wherein the first antenna modulation circuit and the second antenna modulation circuit are in close proximity to one another.
